(19) United States
(12) Patent Application Publication
(10) Pub. No.: US 2013/0244131 A1
(43) Pub. Date: Sep. 19, 2013

(54) Fuel cell modules

(71) Applicants: Vincenzo Arcella, Nerviano (MI) (IT); Giuseppe Marchionni, Milano (IT); Ugo De Patto, Cogliate Milano (IT); Pier Antonio Guarda, Arese (MI) (IT)

(72) Inventors: Vincenzo Arcella, Nerviano (MI) (IT); Giuseppe Marchionni, Milano (IT); Ugo De Patto, Cogliate Milano (IT); Pier Antonio Guarda, Arese (MI) (IT)

(73) Assignee: SOLVAY SPECIALTY POLYMERS ITALY S.P.A., Bollate MI (IT)

(21) Appl. No.: 13/989,283

(22) PCT Filed: Nov. 28, 2011
(86) PCT No.: PCT/EP11/71114

§ 371 Date: May 23, 2013

(30) Foreign Application Priority Data
Dec. 3, 2010 (EP) 10193703.5

(51) Int. Cl. H01M 8/10

(52) U.S. Cl. CPC H01M 8/1006
USPC 429/480; 429/535; 429/482

(57) ABSTRACT

A method for the preparation of corrugated fuel cell units from a composite laminate comprising an ion conductive membrane having first and second surface; a first electrocatalyst layer in contact with the first surface of the membrane; a second electrocatalyst layer in contact with the second surface of the membrane; a first metallic mesh in contact with said first electrocatalyst layer and a second metallic mesh in contact with said second electrocatalyst layer.

### This application claims priority to European application No. 10193703.5, filed on 3 Dec. 2010, the whole content of this application being incorporated herein by reference for all purposes.

### TECHNICAL FIELD

The invention relates in general to fuel cells. In particular the invention relates to corrugated fuel cell units for use in fuel cells provided with a high volumetric power density capability.

### BACKGROUND ART

Fuel cells are electrochemical devices which can convert energy stored in fuels to electrical energy with high efficiencies by oxidation of a fuel and reduction of an oxidizing agent. Among known fuel cells of particular interest are proton exchange membrane (PEM) fuel cells which employ hydrogen as the fuel and oxygen or air as the oxidant.

A typical PEM fuel cell comprises an ion conducting membrane, such as a proton exchange membrane. The membrane separates the fuel on one side of the membrane from the oxidant on the other side of the membrane. The fuel and the oxidizing agent undergo a redox reaction at two isolated electrodes, each containing a catalyst, which are located on each side and in contact with the membrane. The assembly comprising the ion conducting membrane and the electrodes is generally referred to as “membrane-electrode assembly”. The fuel is decomposed liberating ions, typically protons, that migrate through the ion conducting membrane to react with the oxidant, typically generating water as the end product. The redox reactions generate an electromotive force that causes an electrical current to flow in an external circuit.

Other components are typically present in a fuel cell in addition to an ion conducting membrane and the electrodes. The surfaces of the electrodes facing away from the membrane are generally in contact with porous structures, known as gas diffusion layers, whose function is to bring the gaseous reactants (e.g. oxygen and hydrogen in a hydrogen fuel cell) to the surface of the electrodes and at the same time to create an electrical contact with the remaining components of the fuel cell, e.g. the distribution plates.

Distribution plates are rigid suitably shaped sheets made of electrically conductive materials, e.g graphite, carbon composite, metal, or plated metal, positioned on each side of the assembly formed by the membrane, the electrodes and the gas diffusion layers. Distribution plates are impervious to the cell reactants and serve as current collectors, for providing structural support to the membrane and the electrodes. Distribution plates are typically provided with grooves and/or channels for distributing reactants to the electrodes and for removing products, e.g water, formed during the operation of the fuel cell. A distribution plate may distribute fluids to and from two consecutive membranes in a stack, with one face directing fuel to the anode of a first unit, the other face directing oxidant to the cathode of the next unit while at the same time removing water. Hence it is often referred to as “bipolar plate.”

To produce a desired power output a number of unitary cells as described above are generally stacked and electrically connected together, forming what is generally referred to as a “fuel cell stack”.

In such a design, based on the side-by-side stacking of planar unitary cells, only a portion of the electrode is directly exposed to the flow of the gaseous reactants, that is the portion corresponding to the grooves and/or channels in the distribution plates. Such an arrangement limits the amount of current and power that can be produced by a given area of the electrode catalyst.

Additionally, part of the volume of a stack is occupied by the distribution plates whose thickness cannot be reduced below a certain value without risking the loss of mechanical resistance of the plate, also influenced by the presence of the grooves and channels.

Thus, there appears to be a limitation to the volumetric power density that can be attained with the side-by-side stacking of planar unitary cells.

Attempts to improve the volumetric power density of a fuel cell stack by departing from the planar architecture of the fuel cell unit have been described for instance in MERIDA, W. R., et al. Non-planar architecture for proton exchange membrane fuel cells. J. of Power Sources. 2001, no.102, p.178-185. , which discloses a unitary cell having a corrugated design. The cell comprises a corrugated membrane-electrode assembly which is coupled with distribution plates having a corrugated profile, matching the profile of the membrane-electrode assembly. The distribution plates are either made of graphite or of a macroscopically porous stainless steel material.

Similarly, YI, P. Y., et al. A novel design of wave-like PEMFC stack with undulate MEAs and perforated bipolar plates. Fuel Cells. 2010, vol.10, no.1, p.111-117. and CN 101079494 A (UNIV. SHANGHAI JIAOTONG) 28.11.2007 disclose a wave-like corrugated membrane assembly comprising, an ion conducting membrane, gas diffusion layers and electrodes coupled with distribution plates, made of a perforated metallic plate. The perforated metallic plate is shaped by means of a stamping process and then coupled (e.g. by laser welding) with the previously shaped membrane-electrode-gas diffusion layer assembly.

All of these documents describe separately shaping the membrane-electrode assembly on one side and the metallic distribution plates on the other side into a corrugated shape, followed by the coupling of these elements together to form a fuel cell unit.

It would be desirable to have available a method for the preparation of non-planar fuel cell units comprising thin distribution plates wherein all the components of the unit, i.e. the distribution plates, the membrane and the electrodes, may be shaped together at the same time, without physically damaging the membrane portion of the unit.

KR 1020030050034 A (DAELIM INDUSTRIAL CO) 28.01.2005 discloses an assembly comprising a laminate with a corrugated shape. The laminate comprises conductive and heat-transferable porous panels laminated onto a laminated structure which includes a positive electrode, a polymeric electrolyte membrane and a negative electrode. The assembly is manufactured by preparing first a laminated structure including the electrodes, the membrane and the conductive and heat-transferable porous panels; and corrugating the laminated structure into a wave shape.

The conductive and heat-transferable porous panels in KR 1020030050034 A (DAELIM INDUSTRIAL CO) 28.01.2005 are made either of a polymer-based composite material comprising embedded conductive particles (e.g. carbon black, silver, gold, copper or other metallic particles) or of intrinsically conductive polymeric materials (e.g. polyaniline, polypyrrole, polyacetylene). That is the conductive and heat-transferable porous panels are made of materials similar to the components of a membrane-electrode assembly which are expected to be capable of being transformed using similar processing conditions.

Thus, it would be desirable to have a streamlined manufacturing method for the preparation of fuel cell modules comprising thin distribution plates and having a non-planar design starting from composite materials comprising all the components of a fuel cell unit. Such a method should also be capable of being implemented without damaging the physical integrity of the membrane and of the electrocatalytic layers, which typically represent the most expensive components in the stack and on whose integrity relies the proper functioning of the cell.

### SUMMARY OF INVENTION

The Applicant has now found that non-planar fuel cell units can be successfully manufactured with a simplified manufacturing method when a composite material comprising a metallic mesh as distribution plate is used.

Accordingly, a first object of the present invention is a method of manufacturing a corrugated fuel cell unit said method comprising the steps of: providing a continuous sheet of a composite laminate comprising a metallic mesh having a first dimension and a second orthogonal dimension and folding said sheet along said first dimension to form a corrugated structure comprising a plurality of alternating ridges and troughs arranged parallel with each other and with said second dimension. The composite laminate for carrying out the method comprises an ion conductive membrane having first and second surface; a first electrocatalyst layer in contact with the first surface of the membrane; a second electrocatalyst layer in contact with the second surface of the membrane; a first metallic mesh in contact with the surface of the first electrocatalyst layer not in contact with the ion conductive membrane and a second metallic mesh in contact with the surface of the second electrocatalyst layer not in contact with the ion conductive membrane.

Second object of the invention is a corrugated fuel cell unit said unit comprising a continuous sheet of the composite laminate as defined above, said laminate folded to form a corrugated structure comprising a plurality of alternating ridges and troughs arranged in parallel.

Third object of the invention is a composite laminate providing advantageous features when used for the preparation of the corrugated fuel cell units of the second object.

### BRIEF DESCRIPTION OF DRAWINGS

FIG. 1 is a schematic cross-section of a first composite laminate for use in the method of the invention.

FIG. 2 is a schematic cross-section of a second composite laminate for use in the method of the invention.

FIG. 3 is a schematic view of a fuel cell module according to a first embodiment of the invention.

FIG. 4 is a schematic view of a fuel cell module according to a second embodiment of the invention.

FIG. 5 is a polarization curve obtained for the fuel cell unit of Example 2.

### DESCRIPTION OF INVENTION

First object of the invention is a method of manufacturing a corrugated fuel cell unit said method comprising the steps of providing a continuous sheet of a composite laminate as described hereinafter having a first dimension and a second orthogonal dimension; folding said sheet along said first dimension to form a corrugated structure comprising a plurality of alternating ridges and troughs arranged parallel with each other and parallel to said second dimension.

The term “corrugated” is used herein to indicate a material which is shaped into alternating ridges and troughs parallel to each other.

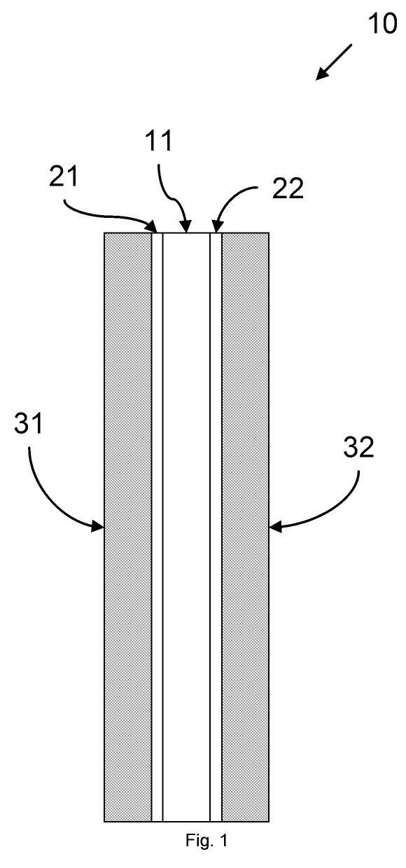

With reference to FIG. 1 the composite laminate for use in the method of the invention, generally identified with the numeral 10, comprises an ion conductive membrane 11 having first and second surface. A first electrocatalyst layer 21 is in contact with the first surface of the membrane. A second electrocatalyst layer 22 is in contact with the second surface of the membrane. A first metallic mesh 31 is in contact with the surface of the first electrocatalyst layer which is not in contact with the ion conductive membrane and a second metallic mesh 32 is in contact with the surface of the second electrocatalyst layer that is not in contact with the ion conductive membrane.

As used herein the term “laminate” refers to the product comprising two or more layers or sheets of material assembled together. Assembling of the layers or sheets in the laminate can be accomplished within the scope of the present invention by simple juxtaposition of the layers or sheets, joining with adhesives, joining with heat and pressure, by coating or printing or any other suitable method. Components may be assembled in the composite laminate using one or more than one assembling method.

As used herein the word “between”, as applied to a laminate component expressed as being between two other specified components, includes both direct adherence of the subject component to one or more of the two other components it is between, as well as including a lack of direct adherence to either or both of the two other components the subject component is between, i.e. one or more additional components can be imposed between the subject component and one or more of the component the subject component is between.

The role of the ion conductive membrane in an electrochemical cell is to allow the passage of ions from one side of the cell to the other to maintain the neutral balance on each side of the cell without allowing the direct reaction of the active species. To guarantee the proper functioning of the fuel cell the physical integrity of the ion conducting membrane should be safeguarded when manufacturing the fuel cell module.

Typically the ion conductive membrane comprises an ion conductive polymeric material. Any suitable ion conductive polymeric material may be used in the composite laminate suitable for the method of the present invention. In general, perfluorinated polymers comprising ionic groups are preferably used as ion conductive materials in fuel cells due to their chemical and thermal resistance.

Ion conductive perfluorinated polymers are generally selected among the copolymers of tetrafluoroethylene and one or more fluorinated monomers comprising an ion exchange group, such as sulfonic acid, carboxylic acid, phosphoric acid groups. More generally ion conductive perfluorinated polymers may be selected among the copolymers of tetrafluoroethylene and one or more fluorinated monomers comprising a precursor group for sulfonic acid, such as F₂C═CF—O—CF₂—CF₂—SO₂F; F₂C═CF—O—[CF₂—CXF—O]ₙ—CF₂—CF₂—SO₂F wherein X═Cl, F or CF₃ and n=1-10; F₂C═CF—O—CF₂—CF₂—CF₂—SO₂F; F₂C═CF—O—CF₂—CF₂—CF₂—CF₂—SO₂F; F₂C═CF—Ar—SO₂F wherein Ar is an aryl ring. Suitable materials are for instance those marketed by E.I. DuPont under the trade name Nafion®, those marketed by Solvay Solexis under the trade name Aquivion™ or those marketed by Asahi Glass Co. under the trade name Flemion®. Fluorine-free, ion conductive polymeric materials such as sulfonated polyether ketones or aryl ketones or acid-doped polybenzimidazoles could also be used.

The ion conductive polymeric material typically has an equivalent weight of no more than 1700 g/eq, more typically of no more than 1500 g/eq, more typically of no more than 1200 g/eq, and most typically of no more than 1000 g/eq. The ion conductive polymeric material typically has an equivalent weight of at least 380 g/eq, preferably at of least 500 g/eq, more preferably of at least 600 g/eq.

EP-A-1323744, EP-A-1179548, EP-A-1167400, EP-A-1589062, EP-A-1702670, EP-A-1702688 disclose suitable ion conductive polymer materials and ion conductive membranes for use in the composite laminate.

The ion conductive membrane may consist of the polymer electrolyte or it may comprise the polymer electrolyte impregnated or coated on a suitable porous support. Among porous supports mention can be made of woven or non-woven polyolefin membranes, in particular polyethylene membranes, and (per)fluoropolymer porous supports. Porous supports of (per)fluoropolymers are generally preferred because of their high chemical inertia. Biaxially expanded PTFE porous supports (otherwise known as ePTFE membranes) are among preferred supports. These supports are commercially available under trade names GORE-TEX®, TETRATEX®.

Typically the ion conductive membrane in the composite laminate sheet has a smooth, flat surface.

Any conventional catalyst used in the art for the preparation of electrodes in fuel cell applications may be used in the preparation of first and second electrocatalyst layers in the composite laminate. The catalyst used in the first and second electrocatalyst layers may be the same or different, but preferably it is the same. Suitable catalysts can be selected from metals such as platinum, palladium, rhodium and alloys thereof. The catalytically active metals or metal alloys can also contain other elements such as ruthenium, cobalt, chromium, tungsten, molybdenum, vanadium, iron, copper, nickel. The metals may be unsupported or supported on suitable electrically conductive particles. Carbon blacks, graphite or active charcoal may advantageously be used as supports. A preferred catalyst for the electrocatalyst layer is generally platinum supported on carbon black.

The electrocatalyst layer may suitably comprise other components, such as ion conductive polymer, which is included to improve the ionic conductivity within the layer. The ion conductive polymer may be selected among the perfluorinated ion conductive polymers which are also suitable for the preparation of ion conductive membranes. Preparation routes for preparing electrocatalyst layers comprising these components are generally known to the skilled person.

Generally the catalyst and the ion conductive polymer, when present, are formulated as dispersion in a suitable solvent, generally referred to as an “ink”, so that electrocatalyst layers can be prepared by standard coating or printing techniques.

First and second metallic meshes are positioned in contact with first and second electrocatalyst layers, respectively, on each side of the composite laminate. As shown in FIG. 1, first metallic mesh 31 is in contact with the first electrocatalyst layer 21 and a second metallic mesh 32 is in contact with the second electrocatalyst layer 22.

The metallic mesh of the composite laminate provides the necessary electrical contact with the electrocatalyst layer and the ion conductive membrane for the flow of electrons and, comprising a net-like structure with openings, allows distributing the reactants to the electrocatalyst layers as well as the removal of the reaction products from the same. The metallic mesh fulfils the role of a distribution plate. Advantageously the metallic mesh used in the composite laminate combines reduced thickness with good pliability, good mechanical resistance as well as electrical conductivity.

The term “mesh” is used herein in its conventional meaning, in that it defines a woven, knit, or knotted material of open texture with evenly spaced holes. Preferably, the metallic mesh is a woven metallic mesh, that is it comprises a first plurality of generally parallel metallic wires weaved together with a second plurality of generally parallel metallic wires disposed generally orthogonal to the first plurality of wires.

In one embodiment, each wire passes alternately over and under another wire. In another embodiment, each wire passes alternately over two other wires and under two further wires.

The physical and electrical properties of the mesh can be optimised by choosing the metallic material used in the preparation of the mesh, varying the thickness of the mesh, the type of mesh (weave style and number of wires), the size of the open area defined by the wires, or the wire diameter.

The metallic mesh for use in the composite laminate can be made of any suitable metal. In general the metal is selected among those metals which have low electrical resistance, pliability, and a high chemical resistance as the environment inside a fuel cell is usually strongly acidic and highly oxidizing. The metal is usually selected from the group consisting of titanium, stainless steel, steel, nickel, nickel alloys, copper alloys, aluminium. Preferably, the metal is selected from the group consisting of titanium, steel, stainless steel. More preferably the metal is stainless steel.

To improve the chemical resistance of the metallic mesh the metal wires may be provided with an anti-corrosion coating or treatment. Suitable coatings are for instance selected among metallic coatings (e.g. platinum, gold, rhodium, ruthenium, palladium) and conductive polymer coatings (e.g. polyaniline).

The wire diameter is typically at least 0.01 mm, preferably 0.02 mm, more preferably 0.05 mm. The wire diameter does not generally exceed 4 mm, preferably 2 mm, more preferably 1 mm.

The thickness of the mesh is approximately two times the diameter of the wire. Thus, the thickness of the mesh is typically in the range from 0.02 to 10 mm, preferably from 0.05 mm to 5 mm, more preferably from 0.1 mm to 2 mm.

The flow of gases through the metallic mesh is generally dependent on the size of the open area defined by the wires in the mesh. The size of the open area is defined in the present specification in terms of the length of the longest side of the open area, which is usually defined as the distance between two consecutive intersections of the wires. A suitable metallic mesh typically has an open area size of at least 0.01 mm, preferably of at least 0.02 mm. Typically the size of the open area does not exceed 5 mm, preferably 4 mm, more preferably 3 mm.

First and second metallic mesh on the two sides of the composite laminate may be the same or they may be different. Advantageously however first and second metallic mesh are different.

In an embodiment the size of the open area in the metallic mesh could be larger on one side of the composite laminate than on the other side. Typically the larger size of the open area will be at least two times, even three times larger than the smaller size of the open area.

In another embodiment the wire diameter of the metallic mesh could be larger on one side of the composite laminate than on the other one. Typically the larger wire diameter will be at least two times, even three times larger than the smaller wire diameter.

In an additional embodiment a metallic mesh having both larger wire diameter and larger open area could be used on one side of the composite laminate, typically the side of the laminate that will represent the oxygen/air side of the fuel cell unit. The composite laminate configuration whereby the first metallic mesh has a size of the open area and/or the wire diameter larger than the size of the open area and/or the wire diameter of the second metallic mesh has shown advantages when the laminate is folded into a corrugated fuel cell unit. Without being bound by theory it is believed that the removal of the water generated in during operation of the fuel cell might be facilitated by having a larger size of the open area and/or the wire diameter on one side of the composite laminate, preferably when this side is oxygen/air side of the fuel cell unit.

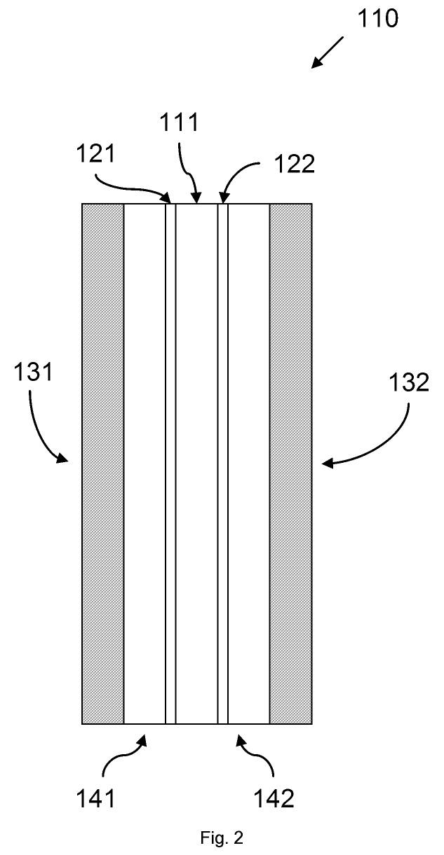

In an embodiment the composite laminate may further comprise a first gas diffusion layer 141 positioned between and in contact with the first metallic mesh 131 and the surface of the first electrocatalyst layer 121. The composite laminate may also comprise a second gas diffusion layer 142 positioned between and in contact with the second metallic mesh 132 and the surface of electrocatalyst layer 122. The latter embodiment, comprising a first and a second gas diffusion layer, is shown in FIG. 2.

When present first and second gas diffusion layers may provide additional protection of the metallic mesh to corrosion.

Non-limiting examples of suitable materials for use as gas diffusion layers include for instance non woven papers or webs comprising a network of carbon fibres and a thermoset resin binder (e.g. Toray® paper available from Toray Industries Inc., Japan, or the Sigracet® series available from SGL Technologies GmbH, Germany), or woven carbon cloths (e.g. the ELAT® series available from BASF Fuel Cell GmbH, Germany).

The components of the composite laminate, i.e. the ion conductive membrane, the electrocatalyst layers, the gas diffusion layers, when present, and the metallic mesh may have the same or different size. Preferably the ion conductive membrane has a size which exceeds the size of each of the electrocatalyst layers, the gas diffusion layers when present, and of the metallic mesh. Generally, the size of the ion conductive membrane exceeds by at least 1 mm, preferably by at least 5 mm and up to 10 cm, preferably up to 5 cm the size of the other components of the composite laminate in each direction to better maintain the electrical insulation between the electrically conductive elements in the composite.

The composite laminate usually has a thickness of at least 0.04 mm, preferably of at least 0.05 mm. The thickness does not generally exceed 20 mm, preferably it does not exceed 10 mm, more preferably it does not exceed 5 mm.

The composite laminate may be prepared using conventional techniques in the preparation of multilayer composite materials. In a first embodiment the composite laminate may be prepared by a process wherein electrocatalyst layers are applied to the first and second surfaces of an ion conductive membrane using a printing or coating technique, to obtain a catalyst-coated membrane. First and second metallic meshes, and optionally first and second gas diffusion layers, are coupled to the so-obtained catalyst-coated membrane, one on each side. Coupling of the metallic mesh to the other components of the composite laminate may be carried out by conventional methods, typically by simple juxtaposition with the remaining components of the laminate.

Alternatively, first and second electrocatalyst layers may be applied to a surface of both the first and second metallic mesh, typically by coating, and then the so-obtained catalyst-coated metallic mesh is coupled to the ion conductive membrane one on each side, so that the electrocatalyst layers are sandwiched between the ion conducting membrane and the metallic mesh.

In a further embodiment, when gas diffusion layers are present in the composite laminate, each electrocatalyst layer could be applied first to the surface of the corresponding gas diffusion layer and then be placed in contact with the first or second surface of the ion conductive membrane using known hot pressing or lamination techniques. First and second metallic mesh would then be coupled to opposing sides of the composite in contact with the surface of each of the gas diffusion layers not in contact with the electrocatalyst layers.

In some instances it may be advantageous to join first and second metallic mesh to the remaining components of the composite laminate by providing a thin layer of adhesive along at least one, preferably at least two opposing edges of the composite laminate.

The electrocatalyst layers are typically uniformly distributed over the surface of the composite laminate, however in some instances it may be convenient to create areas void of the catalyst. In particular it may be convenient to provide in the composite laminate catalyst-free areas arranged in such a way that they will dispose orthogonal with respect to the direction of the corrugations in the final corrugated fuel cell unit.

The composite laminate is generally prepared in a substantially flat configuration, either in the form of discrete sheets or blanks or as a continuous web that may be stored in the form of a roll.

The composite laminate is particularly suitable for the preparation of corrugated fuel cell units. However, the use of the composite laminate is not limited to the preparation of corrugated fuel cell units, but it can be used also for the preparation of units having different configurations, such as planar side-by-side stacks.

The materials used in the preparation of the composite laminate should preferably be capable of being formed in or folded into a corrugated configuration as described below without breaking.

The composite laminate may be formed in or folded into a corrugated shape by any conventional method known in the art for the preparation of corrugated materials.

In an embodiment of the invention the composite laminate is mechanically folded into a corrugated shape by sequentially folding a continuous sheet or web of the composite laminate along a first dimension of said laminate to form a plurality of alternating ridges and troughs which are parallel to each other and to a second dimension of the laminate, the second dimension being orthogonal to the first dimension.

The folding may conveniently be carried out by a folding machine, such as those conventionally known in the art. A typical folding machine comprises two—or in case more—folding knives which are located on opposite sides with respect to the sheet or web of material to be folded during operation; the folding machine further comprises a folding channel, typically orthogonal to the folding knives, defined by two plates and located downstream of the two folding knives. Both folding knives can operate according to the following sequence. At the beginning the lower knife located below the sheet or web of material to be folded, almost completely closes the inlet of the folding channel, covering the edge of the lower plate and bringing its edge almost at the same height of the edge of the upper plate. Subsequently the upper knife, located above the sheet or web of material to be folded, goes down, approaches and is placed before the lower knife, bringing its edge almost at the same height of the edge of the lower plate; in this manner a section of sheet or web of material to be folded is pinched between the two knives and folded in a U-shape above the lower knife. Afterwards the lower knife slips away and goes down in a vertical direction, and the upper knife pushes the corrugated band into the folding channel following a horizontal, or at least parallel to the folding channel, movement. At this time each of the upper and lower knives performs the movements which have been previously described for the other knife to create a further fold in the web of material. The sequence can thus continue until the desired length of corrugated material is formed. Advantageously, by varying the distance between the plates, i.e. the so-called folding channel height, and/or the travel of the knives in a direction which is perpendicular to the direction along which the folding channel extends it is possible to vary the height H of the corrugation.

The folding may also be carried out by stamping of the composite laminate in a suitable mold, provided with a corrugated profile, under suitable temperature and pressure conditions.

The corrugations may have a V-shape, a squared U-shape, a rounded U-shape or an even more rounded wave-shape, depending typically on the properties of the starting composite laminate and on the relative dimensions of the corrugations.

The shape of the corrugations is generally dependent on the bending capability of the composite laminate. By selecting composite laminates which can be bent sharply, the “overhead” of the structure can be made small.

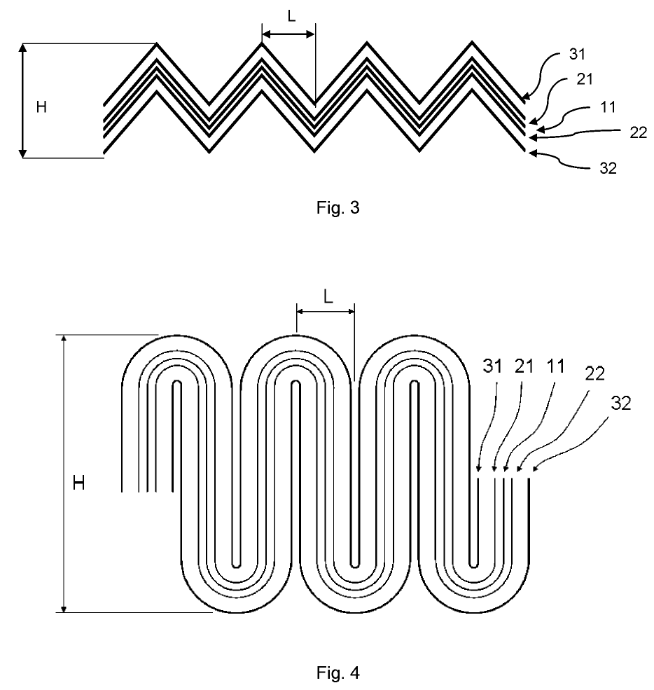

FIG. 3 shows a schematic cross-section of a corrugated fuel cell unit according to one embodiment of the invention having V-shaped corrugations and comprising a composite laminate comprising in the order a first metallic mesh 31, a first electrocatalytic layer 21, an ion conductive membrane 11, a second electrocatalytic layer 22 and a second metallic mesh 32.

A fuel cell unit having rounded U-shaped corrugations is shown in FIG. 4.

The corrugated fuel cell unit may be characterized in terms of its repeat length L, that is half the repeat period of the undulating pattern, of its height H, that is the distance between the top of a ridge and the bottom of the adjacent trough and of the total number of repeat cells N. The values of L, H and N will typically depend on the overall size of the fuel cell unit which in turn depends on the desired output for the cell.

The repeat cell length L is typically at least 0.04 mm, preferably of at least 0.05 mm, even at least 0.1 mm. The repeat cell length L is not particularly limited to a specific upper level although practical repeat cell length values may be 15 cm, even 10 cm or more typically not more than 5 cm.

The height of the fuel cell unit is typically at least 0.08 cm, preferably at least 0.1 cm, more preferably at least 0.5 cm and up to 40 cm, preferably up to 20 cm, even more preferably up to 10 cm.

Preferably, the repeat cell length L is smaller than the height H of the corrugated fuel cell unit as this relationship provides the best, i.e. highest, relationship between the electrochemically active area and than the projected area of the structure itself. In an embodiment of the invention the height H of the corrugated fuel cell unit is at least 2 times the cell length L, typically at least 3 times, preferably at least 5 times the cell length L. The height H of the corrugated fuel cell unit is advantageously up to 30 times, typically up to 20 times the cell length L.

The total number of repeat cells in an unit is at least 2, preferably at least 3 more preferably at least 5. The maximum number of repeat cells is not critical and it can be up to 400, preferably up to 300.

The width of the corrugated fuel cell is not critical and it will generally depend on the final use of the fuel cell unit and the required power output.

The mechanical properties of the composite laminate may affect how tightly the corrugated structure can be folded. The Applicant has found that even when the corrugated structure is folded at its tightest level, so that the external surfaces of the metallic mesh in adjacent folds contact each other, as shown in FIG. 4, the gaseous reactants and the reaction products can still diffuse to and away from the surface of the electrocatalyst layers.

The corrugated fuel cell unit may hold the corrugation after folding; alternatively the corrugated structure may be retained by external means into a corrugated shape.

The corrugated fuel cell unit may be sealed around its edges. Any suitable sealing manner may be used. For example, the edge portions of the fuel cell unit may be encapsulated in a suitable plastic material, creating a carrier for the unit. Suitable plastic materials are for instance thermoplastic materials such as poly(ethylene), poly(propylene), poly(vinylidene fluoride) as well as thermoset materials e.g. epoxy resins. In some embodiments, the carrier may comprise one or more seals or sealing surfaces which permit the carrier to be sealed to a chamber wherein suitable manifolds for the reactants and electrical connections are present.

Further object of the invention is a fuel cell comprising a corrugated fuel cell unit. The fuel cell may comprise one or more than one corrugated fuel cell unit, for instance 2 corrugated fuel cell units, even 5 corrugated fuel cell units, 10 corrugated fuel cell units or even up to 100 fuel cell units depending on the required output.

The corrugated fuel cell units of the invention have been shown to provide fuel cells having a current density of up to 2000 W/l in ventilated conditions.

The corrugated fuel cell units and the fuel cells of the invention, due to the higher volumetric power density with respect to fuel cells based on a planar architecture, may advantageously be used in portable electronic devices, in electrical engines for use in hand-held tools, such as drills, in electrically-powered vehicles such as bicycles and other automotive applications.

The present invention will now be described in more details by reference to the following examples, whose purposes are merely illustrative and do not limit the scope of the invention.

Should the disclosure of any patents, patent applications, and publications which are incorporated herein by reference conflict with the description of the present application to the extent that it may render a term unclear, the present description shall take precedence.

### EXAMPLES

Raw materials

ICM #1: Ion conducting membrane Aquivion™ (supplied by Solvay Solexis SpA) having equivalent weight 894 g/eq and thickness 50 μm.

ICM #2: Ion conducting membrane Aquivion™ (supplied by Solvay Solexis SpA) having equivalent weight 830 g/eq and thickness 90 μm.

ICM #3: Ion conducting membrane Aquivion™ (supplied by Solvay Solexis SpA) having equivalent weight 830 g/eq and thickness 200 μm.

MESH #1: stainless steel (AISI 316) mesh with: thickness 220 μm, open area 140 μm, wire diameter 80 μm.

MESH #2: stainless steel (AISI 316) mesh with a thickness 90 μm, open area 50 μm, wire diameter 40 μm.

MESH #3: stainless steel (AISI 316) mesh with a thickness 50 μm, open area 25 μm, wire diameter 25 μm.

MESH #4: stainless steel (AISI 316) mesh with a thickness 450 μm, open area 300 μm, wire diameter 140 μm.

MESH #5: stainless steel (AISI 316) mesh with a thickness 550 μm, open area 400 μm, wire diameter 160 μm.

GDL #1: Carbon conductive fabric 120 μm thick (supplied by SEAL SAATI group).

GDL #2: Carbon conductive fabric 140 μm thick (supplied by SEAL SAATI group).

Catalytic ink: composed of Pt supported on graphite (supplied by Umicore) mixed with an equivalent weight Aquivion™ ion conducting perfluorinated polymer having an equivalent weight of 830 g/eq dispersed in a water-alcohol mixture.

### Example 1

The two sheet of stainless steel MESH #2 were covered with palladium by electrochemical deposition.

Both surfaces of ICM #1 were spray coated with the catalytic ink. The catalytic coating (3×21 cm) was centred on the surface of the membrane. The active area on each surface contained 0.06 g of supported Pt and 0.04 g of the ion conductive polymer.

A composite laminate was prepared by assembling the following components in the following order: MESH #2 (3×21 cm), catalyst-coated ICM #1 (5×23 cm), MESH #2 (3×21 cm).

The composite laminate was folded to obtain a U-shaped corrugated unit having a height (H) of 0.5 cm and 42 repeat cells (N). The dimensions of the corrugated unit thus obtained were 3×1×0.5 cm and the volume was 1.5 cm³, each exposed face of the corrugated unit measured 3 cm². The corrugated unit was then inserted into a carrier and sealed in place with polyethylene. The external surfaces of the metallic mesh in adjacent folds were placed in contact with each other.

The corrugated unit was inserted into a hydrogen/air testing cell connected to a tool for electrical measurements. Hydrogen was fed at atmospheric pressure; air was fed at two different conditions: with static air or with ventilated air.

The power generated by the cell at 0.6 V was 270 mW under static conditions and 2.5 W under ventilated conditions. The corresponding volumetric power densities were 180 W/l (static conditions) and 1680 W/l (ventilated conditions).

### Example 2

One side of the sheets of the carbon conductive fabric GDL #1 was spray coated with the catalytic ink. After drying, each sheet contained 0.05 g of supported Pt and 0.03 g of the ion conductive polymer.

A composite laminate was prepared by assembling the components in the following order (the size of each of the components is shown in brackets): MESH #1 (3×24 cm), catalyst-coated GDL #1 (3×24 cm), ICM #1 (5×26 cm), GDL #1 (3×24 cm), MESH #2 (3×24 cm). The catalyst-coated side of GDL #1 was assembled in contact with the surface of the ion conductive membrane.

The composite laminate was then folded using a manual folding machine to obtain a U-shaped corrugated unit having a height H of 1 cm and 24 repeat cells (N). The dimensions of the corrugated unit thus obtained were 3.0×1.5×1.0 cm and the volume was 4.5 cm³, each exposed face of the corrugated unit measured 4.5 cm². The corrugated unit was then inserted into a carrier and sealed in place with polyethylene. The external surfaces of the metallic mesh in adjacent folds were arranged to contact each other.

The corrugated unit was inserted into a hydrogen/air testing cell connected to a tool for electrical measurements. The side of the unit comprising the MESH #1, with the larger size of the open area, was positioned on the air side of the cell.

Hydrogen was fed at atmospheric pressure; air was fed at two different conditions: with static air or with ventilated air.

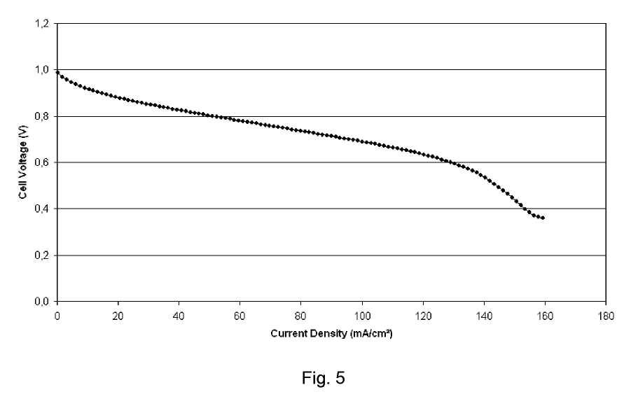

The polarization curve obtained under ventilated air condition is shown in FIG. 5 wherein the current density is referred to the total surface of the composite laminate used in the preparation of the corrugated unit.

The power generated by the cell at 0.6 V was 1.0 W under static conditions and 5.6 W under ventilated conditions. The corresponding volumetric power densities were 213 W/l (static conditions) and 1240 W/l (ventilated conditions).

### Example 3

Following the procedure of Example 2 a composite laminate was prepared by assembling the following components in the following order: MESH #2 (5×52 cm), catalyst-coated GDL #1 (5×52 cm), ICM #2 (7×54 cm), GDL #1 (5×52 cm), MESH #3 (5×52 cm). The catalyst-coated GDL #1 contained 0.21 g of supported Pt and 0.11 g of the ion conductive polymer.

The composite laminate was folded to obtain a U-shaped corrugated unit having a height H of 0.5 cm and 104 repeat cells (N). The dimensions of the corrugated unit thus obtained were 5.0×5.0×0.51 cm and the volume was 25 cm³, each exposed face of the corrugated unit measured 12.5 cm². The corrugated unit was then inserted into a carrier and sealed in place with polyethylene; the external surfaces of the metallic mesh in adjacent folds were arranged to contact each other.

The side of the unit comprising MESH #2 was positioned on the air side of the hydrogen/air testing cell. The power generated by the cell at 0.6 V was 3.1 W under static conditions and 14.1 W under ventilated conditions. The corresponding volumetric power densities were 250 W/l (static conditions) and 1120 W/l (ventilated conditions).

### Example 4

Following the procedure of Example 2 a composite laminate was prepared by assembling the following components in the following order: MESH #2 (20×100 cm), catalyst-coated GDL #1 (20×100 cm), ICM #3 (22×102 cm), GDL #1 (20×100 cm), MESH #4 (20×100 cm). The catalyst-coated GDL #1 contained 1.44 g of supported Pt and 0.72 g of the ion conductive polymer.

The composite laminate was folded to obtain a U-shaped corrugated unit having a height H of 2.0 cm and 50 repeat cells (N). The dimensions of the corrugated unit thus obtained were 20×5.0×2.0 cm and the volume was 200 cm³, each exposed face of the corrugated unit measured 100 cm². The corrugated unit was then inserted into a carrier and sealed in place with poly(vinylidene fluoride). The external surfaces of the metallic mesh in adjacent folds were arranged to contact each other.

The side of the unit comprising MESH #4 was positioned on the air side of the hydrogen/air testing cell. The power generated by the cell at 0.6 V was 41 W under static conditions and 386 W under ventilated conditions. The corresponding volumetric power densities were 200 W/l (static conditions) and 1930 W/l (ventilated conditions).

### Example 5

Following the procedure of Example 2 a composite laminate was prepared by assembling the following components in the following order: MESH #2 (20×228 cm), catalyst-coated GDL #2 (20×228 cm), ICM #3 (22×230 cm), GDL #2 (20×228 cm), MESH #5 (20×228 cm). The catalyst-coated GDL #2 contained 3.34 g of supported Pt and 1.67 g of the ion conductive polymer.

The composite laminate was folded to obtain a U-shaped corrugated unit having a height (H) of 2.5 cm and 91 repeat cells (N). The dimensions of the corrugated unit thus obtained were 20×10×2.5 cm and the volume was 500 cm³, each exposed face of the corrugated unit measured 200 cm ². The corrugated unit was then inserted into a carrier and sealed in place with poly(vinylidene fluoride); the external surfaces of the metallic mesh in adjacent folds were placed in contact with each other.

The side of the unit comprising MESH #5 was positioned on the air side of the hydrogen/air testing cell. The power generated by the cell at 0.6 V was 98 W under static conditions and 971 W under ventilated conditions. The corresponding volumetric power densities were 196 W/l (static conditions) and 1940 W/l (ventilated conditions).

1. A method of manufacturing a corrugated fuel cell unit, wherein said method comprises the steps of:
providing a continuous sheet of a composite laminate comprising an ion conductive membrane having first and second surface; a first electrocatalyst layer in contact with the first surface of the membrane; a second electrocatalyst layer in contact with the second surface of the membrane; a first metallic mesh in contact with said first electrocatalyst layer and a second metallic mesh in contact with said second electrocatalyst layer, said composite laminate having a first dimension and a second orthogonal dimension; and
folding said sheet along said first dimension to form a corrugated structure comprising a plurality of alternating ridges and troughs parallel with each other and with said second dimension.

2. The method according to claim 1 carried out by means of a folding machine.

3. A corrugated fuel cell unit comprising a continuous sheet of a composite laminate comprising an ion conductive membrane having first and second surface; a first electrocatalyst layer in contact with the first surface of the membrane; a second electrocatalyst layer in contact with the second surface of the membrane; a first metallic mesh in contact with said first electrocatalyst layer and a second metallic mesh in contact with said second electrocatalyst layer, said composite laminate is being folded to form a corrugated structure comprising a plurality of alternating parallel ridges and troughs.

4. The corrugated cell unit according to claim 3 wherein said composite laminate further comprises a first gas diffusion layer positioned between said first metallic mesh and the surface of said first electrocatalyst layer not in contact with the ion conductive membrane and, optionally, a second gas diffusion layer positioned between said second metallic mesh and the surface of said second electrocatalyst layer not in contact with the ion conductive membrane.

5. The corrugated fuel cell unit according to claim 3 wherein the cell height H is at least 0.08 mm and at most to 40 cm.

6. The corrugated fuel cell unit according to claim 3 wherein the cell length L is at least 0.04 mm and at most to 20 cm.

7. The corrugated fuel cell unit according to claim 3 wherein the cell height H is at least 2 times the cell length L.

8. The corrugated fuel cell unit according to claim 3 wherein the first and second metallic mesh have a thickness of at least 0.01 mm and up to 4 mm.

9. The corrugated fuel cell unit according to claim 3 wherein the first and second metallic mesh are a woven mesh.

10. The corrugated fuel cell unit according to claim 3 wherein the size of the open area and/or the wire diameter of the first metallic mesh is larger than the size of the open area and/or the wire diameter of the second metallic mesh.

11. A fuel cell comprising the corrugated fuel cell unit of claim 3.

12. A portable electronic device comprising the fuel cell unit of claim 3.

13. A vehicle comprising the fuel cell unit of claim 3.

14. A composite laminate comprising an ion conductive membrane having first and second surface; a first electrocatalyst layer in contact with the first surface of the membrane; a second electrocatalyst layer in contact with the second surface of the membrane; a first metallic mesh in contact with said first electrocatalyst layer and a second metallic mesh in contact with said second electrocatalyst layer characterised in that the size of the open area and/or the wire diameter of the first metallic mesh is larger than the size of the open area and/or the wire diameter of the second metallic mesh.

15. The composite laminate according to claim 14 wherein the size of the open area and/or the wire diameter of the first metallic mesh is at least two times larger than the size of the open area and/or the wire diameter of the second metallic mesh.
